(19) United States
(12) Patent Application Publication
(10) Pub. No.: US 2011/0246302 A1
(43) Pub. Date: Oct. 6, 2011

(54) METHOD AND SYSTEM FOR PROVIDING ADVERTISEMENT USING OPENING BID PRICE

(75) Inventors: Ki Oh Kwon, Yongin-si (KR); Yu Won Kim, Seongnam-si (KR); Won Sook Noh, Seoul (KR); Woong Sup Shin, Seoul (KR); Woo Sung Lee, Yongin-si (KR); Min Seon Jeon, Seoul (KR); Seo Jin Han, Seoul (KR); Ha Nyung Chung, Seoul (KR)

(73) Assignee: NHN BUSINESS PLATFORM CORPORATION, Seongnam-si (KR)

(21) Appl. No.: 13/119,389

(22) PCT Filed: Sep. 17, 2009
(86) PCT No.: PCT/KR2009/004858

§ 371 Date: Jun. 6, 2011

(30) Foreign Application Priority Data
Sep. 18, 2008 (KR) 10-2008-0091542
Sep. 29, 2008 (KR) 10-2008-0095341

(51) Int. Cl. G06Q 30/00

(52) U.S. Cl. 705/14.54

(57) ABSTRACT

Disclosed herein are a method and a system for providing an advertisement using a bidding starting price. The method for providing an advertisement includes: determining a bidding starting price for each keyword based on a minimum cost per click for a keyword and the number of expected clicks for the keyword; determining an area in which an advertisement of an advertiser is to be exposed based on a bidding price per unit time input from the advertiser; and providing the advertisement of the advertiser through the area, wherein the bidding price per unit time has a value of the bidding starting price for each keyword or more.

### TECHNICAL FIELD

The present invention relates to a method and system for providing an advertisement using a bidding starting price, and more particularly, to a method and system for providing an advertisement through a bidding scheme based on a bidding starting price.

### BACKGROUND

An internet advertisement, which is an advertisement using the internet, may allow a company to meet many customers at a low cost and immediately identify response of the customers, through an advertisement using an advantage of a medium called the internet. For example, a keyword advertisement indicates an advertisement method of allowing an advertisement of a related enterprise to be exposed on a screen displaying a search result when a search word is input in a search site. If a user inputs a search word related to ‘removal’, an advertisement related to the removal such as ‘wrapping removal’, ‘removal company’, or the like, may be exposed as a search result of the search word. That is, the advertisement is exposed to persons having specific products or interests, thereby making it possible to accompany a higher advertisement effect.

The internet advertisement is sold as an advertisement product in various forms to an advertiser. Here, in an advertisement product sold in an auction form, an advertisement of an advertiser to be exposed may be determined through a bidding price input from the advertiser. For example, an advertisement of an advertiser suggesting a highest bidding price may be exposed on the top of an advertisement area for the corresponding advertisement product.

Meanwhile, main concern of an advertiser paying a cost for a search advertisement is whether or not he/she may allow the users to effectively experience his/her advertisement within a limited advertisement budget. Therefore, several methods of charging a cost for search advertisement have been developed in order to satisfy the need of the advertiser. As specific charging methods, there are a cost per millennium (CPM) method in which an advertisement cost is calculated according to a number of advertisement exposures to users, a cost per action (CPA) method in which an advertisement cost is calculated according to action results of users, a cost per click (CPC) method in which an advertisement cost is calculated according to a number of selections and clicks of advertisement information (that is, a link of a web page of an advertiser, or the like) by users, or the like.

Meanwhile, the search advertisement is generally sold through auction between a number of advertisers and an advertisement provider. Also in the auction of the search advertisement, the above-mentioned CMP method, CPA method, CPC method, or the like, may be used. For example, in the case in which a biding price is determined according to the CPC method, the advertiser may determine the bidding price regarding ‘an advertisement cost to be paid for per one click’ generated for the search advertisement.

The above-mentioned charging and auction method according to the related art is reasonable in that the advertisement cost is charged according to a generation degree of charging bases (an advertisement exposure, an advertisement information click, or the like). However, it has a disadvantage in that a number of search advertisement exposures or a number of clicks for advertisement information corresponding to the search advertisement has a direct influence on a charging amount. For example, there is often a case in which abnormal many invalid exposures or invalid clicks that do not generate a substantial advertisement effect for a specific search advertisement occur. In this case, the invalid exposures or the invalid clicks are reflected in the charging amount without any filtering, such that the advertisement cost that is to be paid for by the advertiser may be excessively increased. Actually, in a search advertisement industry, acts of abusing the above-mentioned problem to allow a search advertisement of a competitor to be meaninglessly exposed several times or allow advertisement information on the search advertisement of the competitor to be meaninglessly clicked several times are frequently generated. Economic loss of the advertiser due to the invalid exposure or the invalid click has increased day by day. When the economic loss of the advertiser due to the invalid exposure or the invalid click continues, reliability of the advertiser for an advertisement provider may be impaired, such that a search advertisement market may also be reduced.

In order to solve these problems, the present invention relates to a method, system, and a computer-readable medium comprising executable software to determine a cost for a search advertisement to be determined based on a time during which the search advertisement is published in Korean Patent Application No. 2008-91074. However, the present applicant is to provide a more advanced idea than that of the above-mentioned application.

In the present description, a method and system for providing an advertisement in which an advertisement product may be stably sold through effective bidding are suggested.

### SUMMARY

An object of the present invention is to provide a method and system for providing an advertisement in which a bidding starting price for each keyword is determined for an advertisement product sold through bidding for unit time and an advertisement of an advertiser is provided through a determined area according to an input bidding price per unit time based on the bidding starting price for each keyword.

Another object of the present invention is to provide a method and system for providing an advertisement in which a bidding starting price for each advertisement, which is a bidding starting price according to the advertisement, is determined based on a bidding starting price for each keyword and an accomplishment index in which the accomplishment of the advertisement is numerically expressed.

Another object of the present invention is to provide a method and system for providing an advertisement in which a bidding starting price introduced into a new search advertisement model is more accurately determined to provide convenience to an advertiser and to determine an advertisement cost at a more reasonable level.

According to an exemplary embodiment of the present invention, there is provided a method for providing an advertisement, the method including: calculating a bidding starting price based on past data on a search keyword for a search advertisement; transmitting the bidding starting price to an advertiser arithmetic unit; receiving bidding information on the search advertisement from the advertiser arithmetic unit, the bidding information including information on a time during which the search advertisement is to be published and a bidding price for the search advertisement; determining a publication position and/or a publication order of the search advertisement based on an amount of the bidding price corresponding to a predetermined time period within the time during which the search advertisement is to be published in the predetermine time period; and publishing the search advertisement according to the determined publication position and/or publication order for the predetermined time period, wherein the bidding starting price is calculated based on a range that is more likely that a number of search bid advertisements with respect to the search keyword becomes the number of publishable search advertisements or more.

The past data may include at least one of the publication number of a search advertisement for a past predetermined time, the click number of advertisement information on the search advertisement, a bidding price for the search advertisement, a charging amount for the search advertisement, with respect to the search keyword.

The range may be set to a range where the case in which the number of search bid advertisements with respect to the search keyword becomes the number of publishable search advertisements or more occurs even once.

The range may be set to a range where the case in which the number of search bid advertisements with respect to the search keyword becomes a number of publishable search advertisements or more occurs even once for a recent predetermined time.

The range may be set to a range where the case in which the number of search bid advertisements with respect to the search keyword becomes the number of publishable search advertisements or more occurs predetermined times or more for a recent predetermined time.

According to another exemplary embodiment of the present invention, there is provided method for providing an advertisement, the method including: calculating a bidding starting price based on past data on a search keyword for a search advertisement; transmitting the bidding starting price to an advertiser arithmetic unit; receiving bidding information on the search advertisement from the advertiser arithmetic unit, the bidding information including information on a time during which the search advertisement is to be published and a bidding price for the search advertisement; determining a publication position and/or a publication order of the search advertisement based on an amount of the bidding price corresponding to a predetermined time period within the time during which the search advertisement is to be published in the predetermine time period; and publishing the search advertisement according to the determined publication position and/or publication order for the predetermined time period, wherein the bidding starting price is discounted based on a depth for the search keyword.

The discount may be applied when the depth is less than the number of publishable search advertisements.

A discount rate of the discount may be in proportion to a difference value between the number of publishable search advertisements and the depth.

According to another exemplary embodiment of the present invention, there is provided a system for providing an advertisement, the system including: an auction managing unit configured to calculate a bidding starting price based on past data on a search keyword for a search advertisement, to transmit the bidding starting price to an advertiser arithmetic unit, and to receive bidding information on the search advertisement from the advertiser arithmetic unit, the bidding information including information on a time during which the search advertisement is to be published and a bidding price for the search advertisement; and an advertisement executing unit configured to determine a publication position and/or a publication order of the search advertisement based on an amount of the bidding price corresponding to a predetermined time period within the time during which the search advertisement is to be published in the predetermine time period and publishing the search advertisement according to the determined publication position and/or publication order for the predetermined time period, wherein the bidding starting price is calculated based on a range that is more likely that the number of search bid advertisements with respect to the search keyword becomes the number of publishable search advertisements or more.

According to another exemplary embodiment of the present invention, there is provided a system for providing an advertisement, the system including: an auction managing unit configured to calculate a bidding starting price based on past data on a search keyword for a search advertisement, to transmit the bidding starting price to an advertiser arithmetic unit, and to receive bidding information on the search advertisement from the advertiser arithmetic unit, the bidding information including information on a time during which the search advertisement is to be published and a bidding price for the search advertisement; and an advertisement executing unit configured to determine a publication position and/or a publication order of the search advertisement based on an amount of the bidding price corresponding to a predetermined time period within the time during which the search advertisement is to be published in the predetermine time period and to publish the search advertisement according to the determined publication position and/or publication order for the predetermined time period, wherein the bidding starting price is discounted based on a depth for the search keyword.

According to another exemplary embodiment of the present invention, there is provided a method for providing an advertisement, the method including: determining a bidding starting price for each keyword based on a minimum cost per click for a keyword and the number of expected clicks for the keyword; determining an area in which an advertisement of an advertiser is to be exposed based on a bidding price per unit time input from the advertiser; and providing the advertisement of the advertiser through the area, wherein the bidding price per unit time has a value of the bidding starting price for each keyword or more.

The bidding price per unit time may include an expectation cost of the advertiser for providing the advertisement of the advertiser through the area for at least one unit time.

The minimum cost per click may be determined based on a vacancy rate for each keyword, and the vacancy rate may include a rate of a non-sold area within an area in which an advertisement is exposed.

The minimum cost per click may be determined based on at least one of the sale of an advertisement that is exposed through a pre-selected area, the number of clicks of the advertisement, the sale of the same business type advertisement that has been exposed through the area, or the number of clicks of the same business type advertisement.

The number of expected clicks may be determined based on an intermediate value for the exposure number of n advertisements measured on a predetermined date and an expected click rate.

The number of expected clicks may be determined based on the exposure number for which charging is valid and an expected click rate.

According to another exemplary embodiment of the present invention, there is provided a system for providing an advertisement, the system including: a bidding starting price for each keyword determining unit configured to determine a bidding starting price for each keyword based on a minimum cost per click for a keyword and the number of expected clicks for the keyword; an area determining unit configured to determine an area in which an advertisement of an advertiser is to be exposed based on a bidding price per unit time input from the advertiser; and an advertisement providing unit providing the advertisement of the advertiser through the area, wherein the bidding price per unit time has a value of the bidding starting price for each keyword or more.

According to another exemplary embodiment of the present invention, there is provided a method for providing an advertisement, the method including: confirming a bidding starting price for each keyword; confirming an accomplishment index in which the accomplishment of an advertisement is numerically expressed; and determining a bidding starting price for each advertisement based on the bidding starting price for each keyword and the accomplishment index.

According to another exemplary embodiment of the present invention, there is provided a system for providing an advertisement, the system including: a bidding starting price for each keyword confirming unit configured to confirm a bidding starting price for each keyword; an accomplishment index confirming unit configured to confirm an accomplishment index in which the accomplishment of an advertisement is numerically expressed; and a bidding starting price for each advertisement determining unit configured to determine a bidding starting price for each advertisement based on the bidding starting price for each keyword and the accomplishment index.

### BRIEF DESCRIPTION OF THE DRAWINGS

FIG. 1 is a view schematically showing a constitution of the entire system according to an exemplary embodiment of the present invention;

FIG. 2 is a view showing an internal configuration of a search advertisement system according to an exemplary embodiment of the present invention in detail;

FIG. 3 is a view illustratively showing an interface screen representing that bidding prices are determined for each specific time period with respect to a specific search keyword according to an exemplary embodiment of the present invention;

FIG. 4 is a view illustratively showing an interface screen representing that bidding state information is provided with respect to a specific search keyword according to an exemplary embodiment of the present invention;

FIG. 5 is a view illustratively showing an interface screen representing that a search advertisement and a general search result are provided with respect to a specific search keyword according to an exemplary embodiment of the present invention;

FIG. 6 is a view illustratively showing an interface screen representing that information on depth is provided with respect to a specific search keyword according to an exemplary embodiment of the present invention;

FIG. 7 is a view showing a portion of a search result page screen corresponding to a keyword input from a user;

FIG. 8 is a flowchart showing a method for providing an advertisement according to an exemplary embodiment of the present invention;

FIG. 9 is a view showing information on weights for each day of the week;

FIG. 10 is a view showing information on weights for a specific day;

FIG. 11 is a table including information on weights for a day of the week and a specific day;

FIG. 12 is a block diagram describing an internal configuration of a system for providing an advertisement according to an exemplary embodiment of the present invention;

FIG. 13 is a flowchart showing a method for providing an advertisement according to another exemplary embodiment of the present invention;

FIG. 14 is a block diagram describing an internal configuration of a system for providing an advertisement according to another exemplary embodiment of the present invention; and

FIG. 15 is a view describing a price bidding per unit time.

### DETAILED DESCRIPTION OF EMBODIMENTS

Exemplary embodiments of the present invention will be described in detail with reference to the accompanying drawings. These exemplary embodiments will be described in detail for those skilled in the art in order to practice the present invention. It should be appreciated that various embodiments of the present invention are different but do not have to be exclusive. For example, specific shapes, configurations, and characteristics described in an exemplary embodiment of the present invention may be implemented in another exemplary embodiment without departing from the spirit and the scope of the present invention. In addition, it should be understood that position and arrangement of individual components in each disclosed exemplary embodiment may be changed without departing from the spirit and the scope of the present invention. Therefore, a detailed description described below should not be construed as being restrictive. In addition, the scope of the present invention is defined only by the accompanying claims and their equivalents if appropriate. The similar reference numerals will be used to describe the same or similar function throughout the accompanying drawing.

Hereinafter, exemplary embodiments of the present invention will be described in detail with reference to the accompanying drawings so that those skilled in the art may easily implement the spirit of the present invention.

In the present description, a search advertisement calls collectively an advertisement method of allowing advertisement information such as a uniform resource locator of an advertiser, a one-line advertisement message, an image advertisement, or the like, to be published at a specific position on a search result page in the case in which users perform search with a specific search clue (for example, a search keyword) using a search engine, or an advertisement using the same. Particularly, the search advertisement described in the present description should be understood as a widest sense including a keyword advertisement in which an advertisement related to a search keyword input by users is published together with a search result provided by a search site according to the search keyword.

In addition, in the present description, charging calls collectively a series of process of imposing a cost to an advertiser at the cost of search advertisement publication for the advertiser. Particularly, the charging advertisement described in the present description should be understood as a widest sense including all of a cost per millennium (CPM) method in which an advertisement cost is calculated according to the number of advertisement exposures to users, a cost per action (CPA) method in which an advertisement cost is calculated according to an action result of users, a cost per click (CPC) method in which an advertisement cost is calculated according to the number of selections and clicks of an advertisement by users, a cost per time (CPT) method in which an advertisement cost is calculated based on a time during which an advertisement is published, or the like.

In the present description, the CPT method indicates a new charging method of allowing an advertiser to bid for a predetermined search keyword and a predetermined time (period) at a cost set by him/her in order to publish his/her search advertisement at a predetermined position on a search result page, allowing an advertisement to be published whenever users perform search (query) with the search keyword during the time, and allowing an advertisement cost due to the advertisement publication to be basically determined according to a biding price and a time during which the advertisement is published.

According to the CPT method, a plurality of search advertisements (of different advertisers if there are many advertisers) by a single search keyword may be basically arranged and displayed on a search result page according to a bidding price (according to a high bidding price order) for the respective advertisements. Here, other variables (for example, a class of an advertiser, an accumulative charging amount for the advertiser) in addition to the bidding price may be referenced in determining a position of a search advertisement.

Although the bidding is performed for a single search advertisement, it may be separately treated for each time period (in this case, the bidding price may be changed for each time period according to the selection of an advertiser). Arranged positions of search advertisements may be changed for each time period.

In spite of the above description, the CPT method according to the present invention is not limited to the above-mentioned contents. A right for all the CPT methods disclosed or implied in a detailed description below may be considered as pertaining to the present invention.

Hereinafter, exemplary embodiments of the present invention will be described in detail with reference to the accompanying drawings.

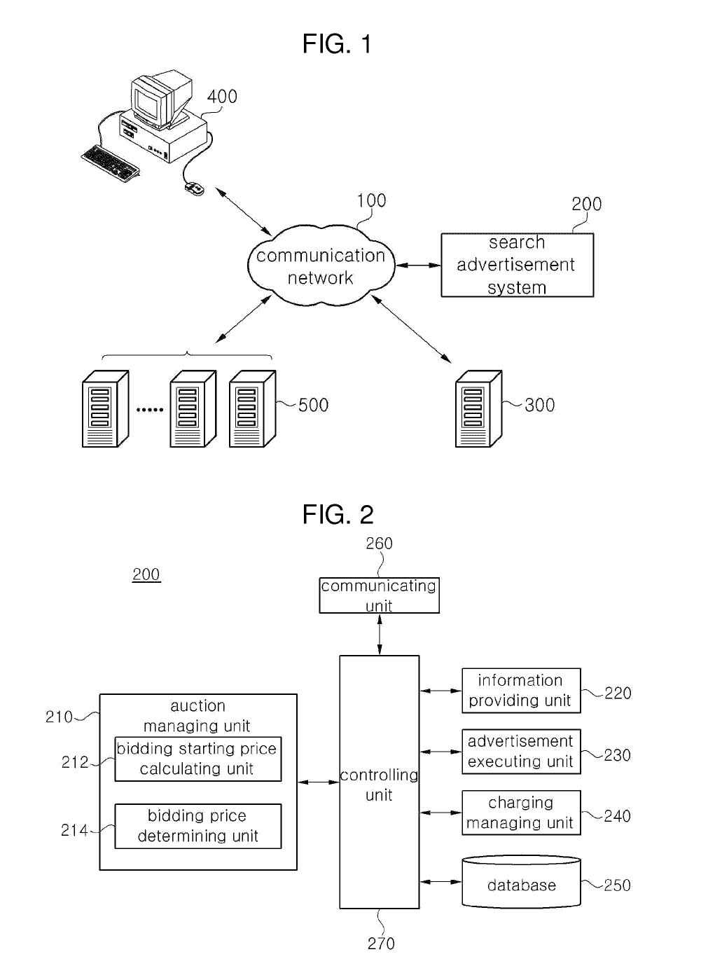

FIG. 1 is a view schematically showing a constitution of the entire system according to an exemplary embodiment of the present invention.

As shown in FIG. 1, the entire system according to an exemplary embodiment of the present invention may be configured to include a communication network 100, a search advertisement system 200 configured to perform auction and to charge for a search advertisement based on a time during which the search advertisement is published, an advertiser server (or an advertiser terminal device) 300, and a user terminal device 400, and a plurality of web servers 500 configured to search and provide contents according to a search clue received from the user terminal device 400 according to the request of the user.

First, the communication network 100 may be configured regardless of a communication aspect such as a wired communication and a wireless communication, and may be various communication networks such as a local area network (LAN), a metropolitan area network (MAN), a wide area network (WAN), or the like. The communication network 100 described in the present invention may be the known World Wide Web (WWW).

According to the exemplary embodiment of the present invention, the search advertisement system 200 may serve to allow an advertiser to bid for a specific search keyword based on a time during which a search advertisement is published in performing auction for the search advertisement. The search advertisement system 200 may calculate a bidding starting price for a specific keyword based on past data (data on the publication number of a search advertisement for a past predetermined time, the click number of advertisement information, a charging amount, or the like) and provide the calculated bidding starting price to the advertiser, in order to support the advertiser so that he/she may determine an amount appropriate for an expected advertisement effect for a search advertisement by a specific search keyword as a bidding price.

According to the exemplary embodiment of the present invention, the search advertisement system 200 may serve to provide information (an expected rank at the time of bidding, a highest bidding price, or the like) on a current or recent bidding state to advertisers participating in bidding for a specific search advertisement and to allow the advertisers to provide opportunity capable of changing a bidding price set by him based on the information on the bidding state.

In addition, according to the exemplary embodiment of the present invention, the search advertisement system 200 may serve to publish a search advertisement of an advertiser successfully bidden by the above-mentioned auction process, corresponding to search keywords input by users.

Furthermore, according to the exemplary embodiment of the present invention, when the publication of the search advertisement is finished for a predetermined time, the search advertisement system 200 may serve to determine a charging amount based on a bidding price and a time during which the search advertisement is published.

According to the exemplary embodiment of the present invention, the advertiser server 300 may be a server including a function of allowing the advertiser to access the search advertisement system 200 and then communicate therewith. However, digital devices such as a personal computer (for example, a desktop computer, a notebook computer, or the like), a workstation, a personal digital assistance (PDA), a web pad, a mobile phone, or the like, may be used as a configuring device or an advertiser terminal device of the advertisement server 300 according to the present invention if they include a memory unit and a micro-processer to thereby have operational capability. More specifically, the advertiser server 300 according to the exemplary embodiment of the present invention may serve to provide information on a search advertisement which the advertiser is to publish and a biding price (for example, a bidding price for each time period and the total bidding price according to the bidding price for each time period) to the search advertisement system 200 and to receive information on a bidding starting price and a bidding state from the search advertisement system 200. The advertiser server 300 may also be a homepage operating server operated by the advertiser in order to provide a product or a service.

Meanwhile, the user terminal device 400 according to the exemplary embodiment of the present invention may be a digital device including a function of allowing the user to access the web server 500 and then communicate therewith, through the communication network 100. Digital devices such as a personal computer (for example, a desktop computer, a notebook computer, or the like), a workstation, a PDA, a web pad, a mobile phone, or the like, may be used as the user terminal device 400 according to the present invention if they include a memory unit and a micro-processer to thereby have operational capability. In addition, the user terminal device 400 may further include a web browser (not shown) program allowing the user to receive contents by requiring the web server 500 for the contents.

According to the exemplary embodiment of the present invention, the web server 500 communicates with the search advertisement system 200 and the user terminal device 400 through the communication network 100. The web server 500 may include a web contents search engine (not shown) to thereby store a search keyword input by the user therein, search the contents corresponding to the search keyword, and provide a search result so that the user may browse the search result. For example, the web server 500 may be an operation server of an internet search portal site. The contents provided as the search result may be various information on news, knowledge, game, community, or the like. The web content search engine may also be included in other arithmetic unit or recording medium rather than the web server 500, as needed. In addition, although FIG. 1 shows a case in which the search advertisement system 200 and the web server 500 are separately configured, the search advertisement system 200 may also be configured to be included in the web server 500 providing a search service in the case in which a search service for contents and a search advertisement server are together provided, as needed, by those skilled in the art implementing the present invention.

Hereinafter, an internal configuration and functions of each component of a search advertisement system 200 performing an important function for implementing the present invention will be described.

FIG. 2 is a view showing an internal configuration of a search advertisement system 200 according to an exemplary embodiment of the present invention in detail. Referring to FIG. 2, a search advertisement system 200 according to an exemplary embodiment of the present invention may be configured to include an auction managing unit 210, an information providing unit 220, an advertisement executing unit 230, a charging managing unit 240, a database 250, a communicating unit 260, and a controlling unit 270. The auction managing unit 210 may include a bidding starting price calculating unit 212, a bidding price determining unit 214, and the like. According to the exemplary embodiment of the present invention, at least some of the auction managing unit 210, the information providing unit 220, the advertisement executing unit 230, the charging managing unit 240, the database 250, the communicating unit 260, and the controlling unit 270 may be program modules communicating with the advertiser server 300 and/or the user terminal device 400. These program modules may be included in a form of an operating system, an application program module and other program module in the search advertisement system 200, and be physically stored on several known storage devices. In addition, these program modules may also be stored in a remote storage device capable of communicating with the search advertisement system 200. Meanwhile, the program modules include a routine, a sub-routine, a program, an object, a component, a data structure, or the like, to perform a specific task or executing a specific abstract data type as described below according to the present invention without being limited thereto.

First, the auction managing unit 210 according to the exemplary embodiment of the present invention may serve to calculate a bidding starting price and to determine a bidding price, for a search keyword selected by an advertiser, so that auction for the search keyword may be performed base on time. In addition, when a biding process ends, the auction managing unit 210 may also serve to allow N advertisers suggesting high bidding prices to be successfully bidding for the search advertisement by the search keyword based on biding prices of each advertiser. Hereinafter, an internal configuration and functions of each component of the auction managing unit 210 according to the exemplary embodiment of the present invention will be described with reference to FIG. 2.

The bidding starting price calculating unit 212 may serve to provide past data on a search keyword selected by an advertiser and/or to calculate and provide a bidding starting price for a search advertisement capable of being determined based on the past data.

Here, the bidding starting price, which indicates an initial bidding price differentially calculated according to advertisement effects of each search keyword, serves as an index representing (at least implying) an advertisement effect of a search keyword. As described in the present invention, in the auction of determining the bidding price for the search keyword based on a time on which the search advertisement is published, when a bidding starting price in which an advertisement effect or an advertisement value of the search keyword is reflected is provided as an initial bidding price, an advertiser may reference the bidding starting price as a reasonable reference in setting his bidding price, and an advertisement provider may sell the search advertisement at a reasonable cost. According to the exemplary embodiment of the present invention, the bidding starting price may be calculated based on a time during which the search advertisement is published. A period of the time may be specified by time units such as a year, a month, a day, an hour, a minute, and the like. In addition, according to the exemplary embodiment of the present invention, the bidding starting price may serve as the lowest limit of a successful bidding price for the search advertisement by a specific search keyword in order to prevent the specific search keyword from being successfully bidding at a low price.

According to the exemplary embodiment of the present invention, the bidding starting price may be determined based on data on the search advertisement for which charging previously ends (or a charging amount is determined) with respect to the same search keyword among past data as described above. As an example, an amount charged for the search advertisement for an immediately previous time period made with respect to the same search keyword may be calculated as the bidding starting price. As another example, an average value of amounts charged for the search advertisement for several time periods made with respect to the same search keyword may be calculated as the bidding starting price. As another example, the lowest amount charged for the search advertisement for each time period of several time periods with respect to the same search keyword may be calculated as the bidding starting price.

Meanwhile, in the above-mentioned several examples, it should be understood that the past data does not necessarily have to be data collected for a search advertisement according to the CPT method according to the present invention if it is data on a corresponding search keyword. That is, in the case in which any advertisement provider has provided a search advertisement and has charged for the search advertisement according to an CPC method or other method, with respect to a search keyword “dermatology”, the bidding starting price according to the exemplary embodiment of the present invention may also be calculated using data on the search advertisement.

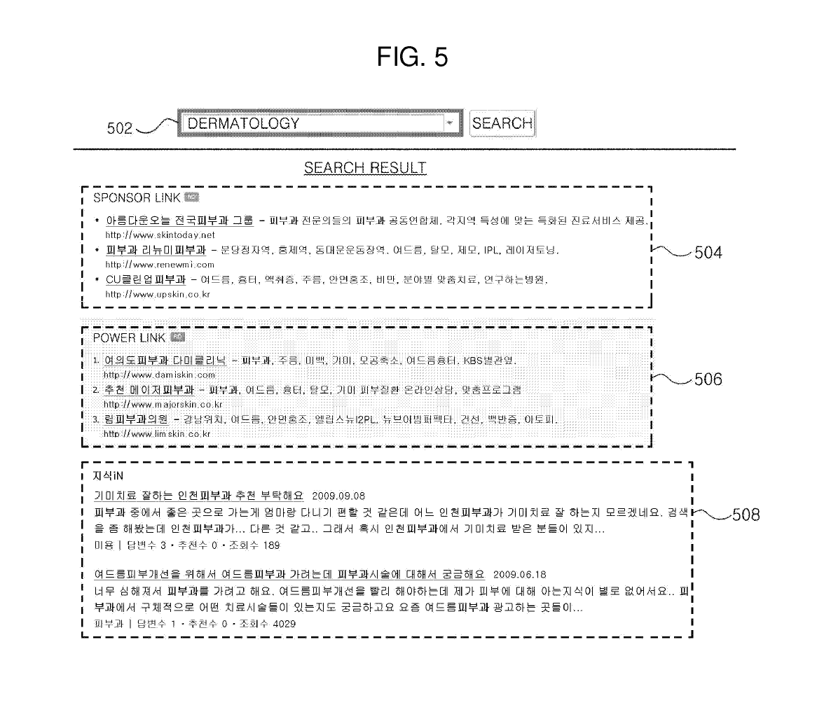

Meanwhile, according to the exemplary embodiment of the present invention, the bidding starting price calculating unit 212 may also perform processing to prevent the search advertisement not from successful bidding. For example, the bidding starting price calculating unit 212 may calculate a range of a bidding starting price that is more likely that the number of search bid advertisements with respect to a specific search keyword becomes the number of publishable search advertisements or more (since users basically perform search while expecting general search information such as news, knowledge, or the like, rather than advertisement information, the number of search advertisements capable of being published on a search result page is slightly limited. For example, in the case of FIG. 5, the number of the search advertisements capable of being published at each advertisement position may be 3) in the light of the past data and calculate an intermediate value in the range of the bidding starting price or a specific value in the range of the bidding starting price as the bidding starting price. For example, the range may be set to a range where the case in which the number of search bid advertisements with respect to the specific search keyword becomes the number of publishable search advertisements or more occurs even once, be set to a range where the above-mentioned case occurs even once for a recent predetermined time, or be set to a range where the above-mentioned case occurs predetermined times or more for a recent predetermined time.

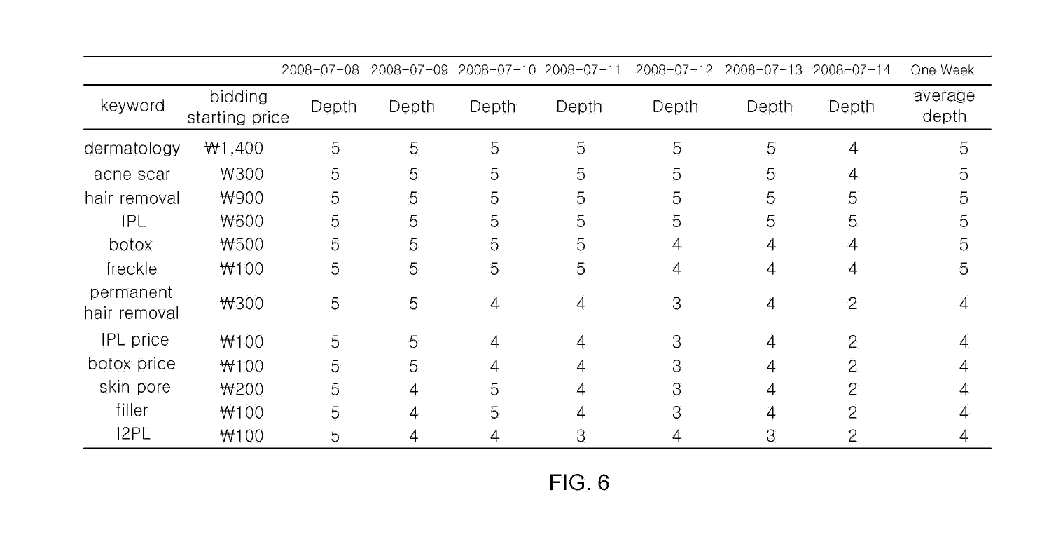

According to the exemplary embodiment of the present invention, the bidding starting prices may be slightly discounted before being provided to the advertiser. Assume a case in which the total number of search advertisements capable of being published by a search act of the user is five. In this case, the bidding starting price calculating unit 212 may apply a predetermined discount rate to a bidding starting price for a search keyword having relatively low popularity. To this end, for example, the biding starting price calculating unit 212 may use the concept of depth as shown in FIG. 6. Here, the depth may be understood to indicate the number (for example, the average number) of search advertisements published at any search advertisement publication position for a predetermined time. The bidding starting price calculating unit 212 may confirm the depths with respect to each search keyword based on the database 250 and apply a predetermined discount rate to a bidding starting price in the case in which the depth is smaller than the number of publishable search advertisements. That is, in the case of FIG. 6, a predetermined discount rate may be applied to bidding starting prices for search keywords under “permanent hair removal” The discount rate may be previously determined by an advertisement provider or be calculated to be in proportion to a difference value between the number of publishable search advertisements and the depth.

The bidding price determining unit 214 according to the exemplary embodiment of the present invention may serve to determine a bidding price according to the setting of an advertiser. According to the exemplary embodiment of the present invention, the bidding price of the advertiser may be determined as an amount in which a bidding correction price added by the advertiser to the bidding starting price first suggested by the bidding starting price calculating unit 212 or subtracted by the advertiser therefrom is reflected. Here, the bidding correction price may be determined according to the intention of the advertiser to thereby be transmitted from the advertiser server 300 to the search advertisement system 200. For example, if the bidding price is set to be higher than the bidding starting price of the advertiser, the bidding correction price has a positive value. Otherwise, the bidding correction price has a negative value. The advertiser may also directly input his desired bidding price from the advertiser server 300 to the search advertisement system 200, while referencing the bidding starting value.

The bidding price determining unit 214 according to the exemplary embodiment of the present invention may limit a range of the bidding price which a specific advertiser may determine in order to prevent him from suggesting an excessively high bidding price for the purpose of causing economic damage to other advertiser without true bidding intention. For example, the bidding price determining unit 214 may limit the bidding price of the advertiser so as not to exceed 1000% of the bidding starting price. In addition, according to the exemplary embodiment of the present invention, the bidding price determining unit 214 may also serve to provide opportunity capable of changing a previously determined bidding price to the advertiser for the flexibility of auction.

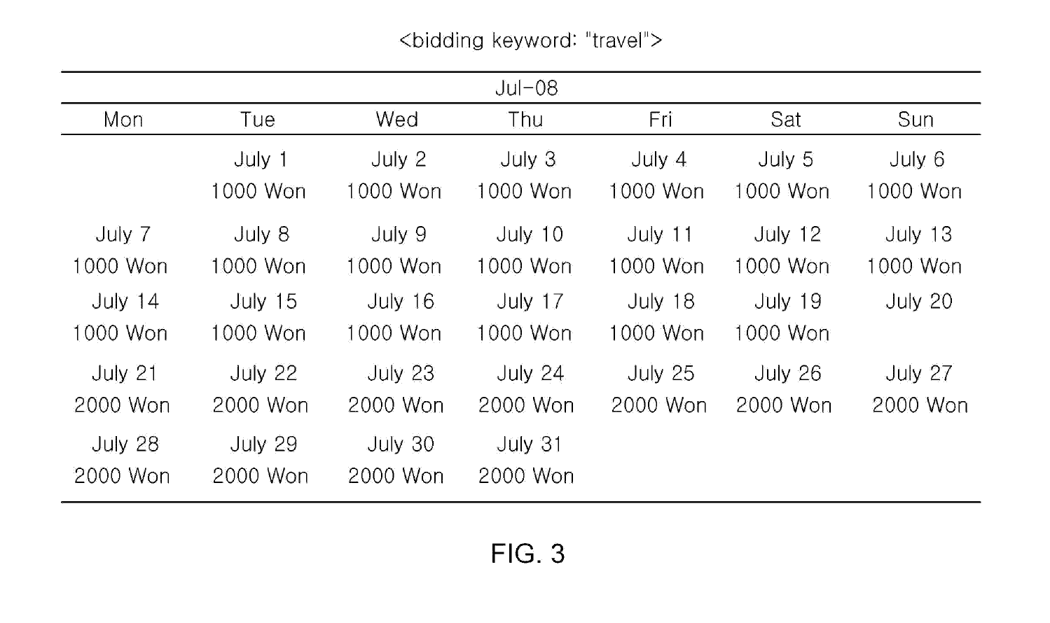

FIG. 3 is a view illustratively showing an interface screen representing that bidding prices are determined for each specific time period with respect to a specific search keyword according to an exemplary embodiment of the present invention.

Referring to FIG. 3, it may be appreciated that a cost for a search advertisement published for a day with respect to a search keyword ‘travel’ is determined as a bidding price. A bidding price is determined as ‘1000 won per one day publication’ in a time period from Jul. 1, 2008 to Jul. 19, 2008 and is determined as ‘2000 won per one day publication’ in a time period from Jul. 21, 2008 to Jul. 31, 2008. However, it should be understood that the bidding price for the search advertisement does not necessarily need to be determined in one day unit or over several days.

Next, according to the exemplary embodiment of the present invention, the information providing unit 220 serves to provide information which the advertiser requires in determining the bidding price in an auction process for the search advertisement to the advertiser server 300. More specifically, the information providing unit 220 according to the exemplary embodiment of the present invention may provide past statistics information for a search advertisement by a specific search keyword in order to remove the uncertainty for an advertisement effect and support the advertiser so that he/she may guess the value of the search advertisement for which he/she is to bid. Here, the past statistics information may include information such as the exposure number of advertisement information (the publication number of search advertisement) for a past predetermined time, a rate between the publication number of search advertisement and the exposure number of advertisement information (that is, a click through rate (CTR)), a rank of the number of exposure of advertisement information, a rank of the publication number of search advertisement, or the like.

In addition, the information providing unit 220 according to the exemplary embodiment of the present invention may provide bidding state information for a specific search keyword in order to support the advertiser so that he/she may guess successful bidding possibility in an auction process of the search advertisement and determine his/her bidding price. The bidding state information may include information such as a bidding rank expected when the bidding is performed at a predetermined bidding price, a highest bidding price, or the like.

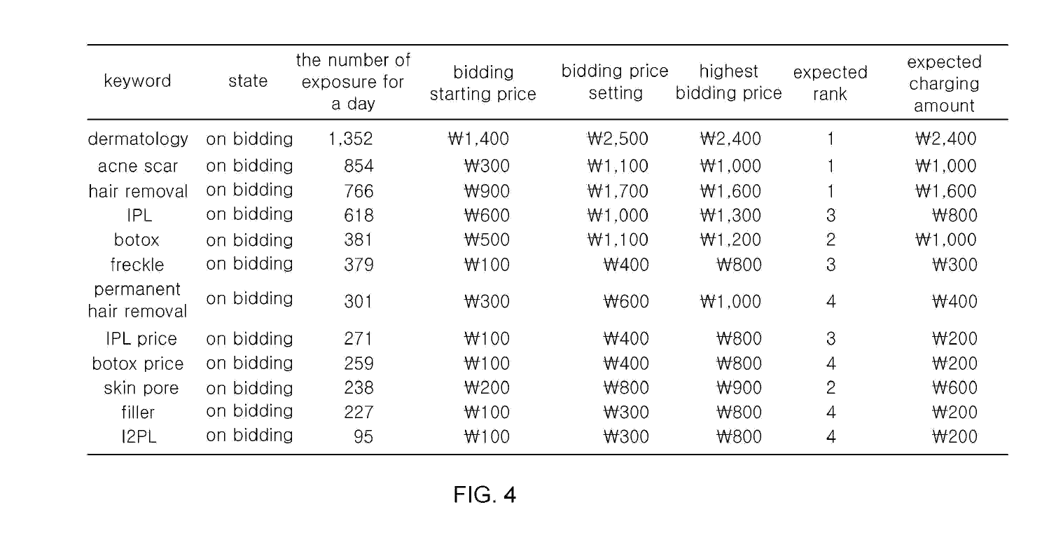

FIG. 4 is a view illustratively showing an interface screen representing that bidding state information is provided with respect to a specific search keyword according to an exemplary embodiment of the present invention.

Referring to FIG. 4, it may be appreciated that information such as a bidding state, a bidding starting price, a currently set bidding price, a highest bidding price, an expected bidding rank, an expected charging amount, or the like, for each search keyword is provided.

Next, according to the exemplary embodiment of the present invention, the advertisement executing unit 230 serves to publish the search advertisements of the advertisers successfully bidding in the auction process corresponding to an input search keyword. That is, the advertisement executing unit 230 may publish the search advertisements of the advertisers successfully bidding with respect to the search keyword while providing a search result corresponding to the input search keyword.

More specifically, the advertisement executing unit 230 according to the exemplary embodiment of the present invention may determine publication positions and/or publication orders of the search advertisements according to ranks of bidding prices of each search advertisement, thereby making it possible to allow the search advertisement having a high bidding price to be published at a relatively advantageous position. In addition, the advertisement executing unit 230 according to the exemplary embodiment of the present invention may determine whether or not each search advertisement is published according to an advertisement publication time set for each search advertisement, thereby making it possible to stop the publication of the search advertisement for which the advertisement publication time expires and begin the publication of the search advertisement for which the advertisement publication time starts. Therefore, according to the exemplary embodiment of the present invention, a specific search advertisement has a rank of the bidding price changed for each of the several time periods during the publication thereof, such that it may be published at different positions for each time period.

FIG. 5 is a view illustratively showing an interface screen representing that a search advertisement and a general search result are provided with respect to a specific search keyword according to an exemplary embodiment of the present invention. Referring to FIG. 5, it may be appreciated that successfully bidding search advertisements 504 and 506 and a general search result corresponding to a “dermatology” 502 are provided, as a search result 508 for a search keyword 502 “dermatology”.

According to the exemplary embodiment of the present invention, it may be appreciated that a plurality of search advertisements 504 and 506 are published at different positions on a screen according to a predetermined order. A publication position and/or a publication order of the search advertisement may be determined according to an amount of a bidding price of a corresponding search advertisement. For example, a search advertisement published at a position of a sponsor link 504 expected to have a relatively higher advertisement effect may have a bidding price higher than that of a search advertisement published at a position of a power link 506 expected to have a relatively lower advertisement effect. In addition, a search advertisement corresponding to a highest bidding price among search advertisements published in the sponsor link 504 may be published at a first line of the position of the sponsor link 504.

Next, the charging managing unit 240 according to the exemplary embodiment of the present invention may perform charging for a search advertisement of which publication is finished. As described above, the charging managing unit 240 may calculate a charging amount based on a specific time period during which the search advertisement is published. For example, when a search advertisement successfully bidding at ‘10,000 won per one day publication’ with respect to the search keyword “dermatology” is published for ten days, the charging managing unit 240 may calculate 100,000 won as a charging amount.

Meanwhile, the database 250 according to the exemplary embodiment of the present invention may have several data on the search advertisement stored therein. For example, the database 250 may have the above-mentioned past data on the search advertisement, the various statistics information, the bidding state information, or the like, stored therein.

Meanwhile, although FIG. 2 shows a case in which the database 250 is configured to be included in the search advertisement system 200, the database 250 may be configured separately from the search advertisement system 200, as needed, by those skilled in the art implementing the present invention. Meanwhile, the database 250 according to the present invention, which is a concept including a computer-readable recording medium, includes a database in a broad sense including file system based data recording, or the like, as well as a database in a narrow sense. It should be appreciated that even a set of simple logs may be included in the database 250 described in the present invention if it may be searched to extract data.

The communicating unit 260 according to the exemplary embodiment of the present invention serves to enable data to be transmitted to/received from the search advertisement system 200.

The controlling unit 270 according to the exemplary embodiment of the present invention serves to control flow of data among the auction managing unit 210, the information providing unit 220, the advertisement executing unit 230, the charging managing unit 240, the database 250, and the communicating unit 260. That is, the controlling unit 270 according to the exemplary embodiment of the present invention controls the flow of data from the outside or between each components of the search advertisement system 200 to thereby control the auction managing unit 210, the information providing unit 220, the advertisement executing unit 230, the charging managing unit 240, the database 250, and the communicating unit 260 so as to perform is their unique functions.

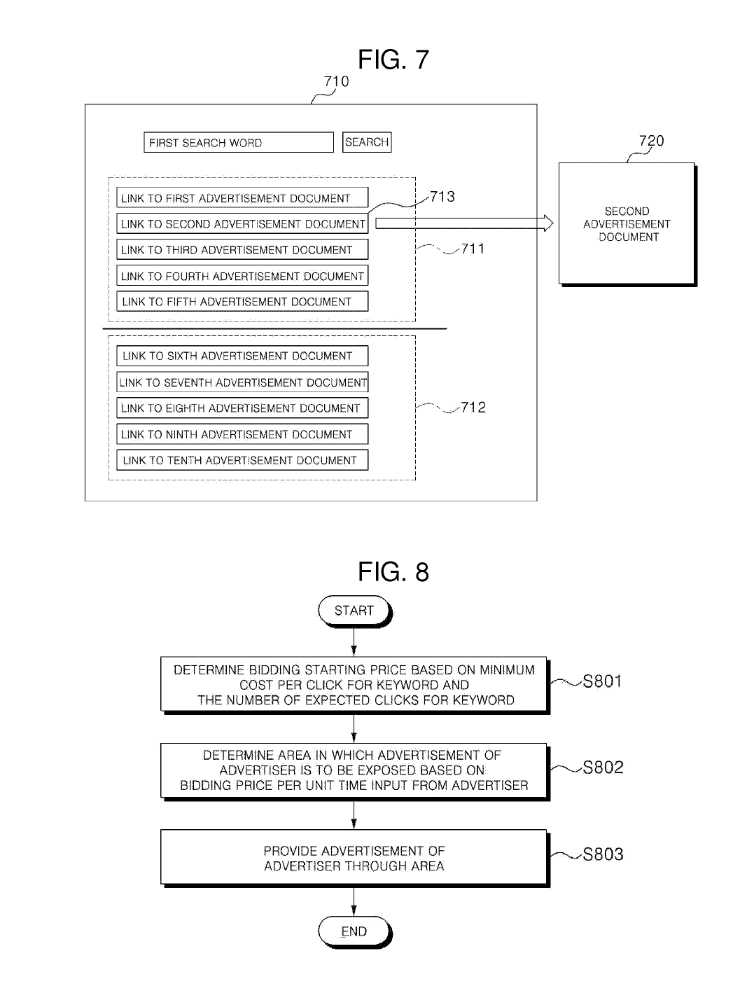

FIG. 7 is a view showing a portion of a search result page screen corresponding to a keyword input from a user. A search result page 710 is a page including a search result for a first search word input from a user. In the search result page 710, links to an advertisement documents may be set for each advertisement product, as shown in two dotted line boxes 711 and 712. That is, the search result page 710 represents an example in which links to five advertisement documents are set for each of the two advertisement products.

Here, when a click event for link 713 to a second advertisement document occurs by the user, the second advertisement document 720 may be provided to the user. The link to the advertisement document may be set in a sold area in the case in which a corresponding advertisement product is purchased according to a keyword such as a first search word. The area may be sold in a format of auction. The system for providing an advertisement according to the exemplary embodiment of the present invention determines a bidding starting price to be used in the auction for the sale of the area, thereby making it possible to determine an appropriate successful bidding price even for a less competitive keyword.

In addition, the bidding price input from the advertiser may include a bidding price per unit time, which is an expectation cost of the advertiser for providing the advertisement of the advertiser through the area for at least one unit time. In this case, the system for providing an advertisement may also use the bidding starting price in order to prevent advertisements of advertisement products sold at the bidding price for a cost per click from being leaked as advertisement products sold at the bidding price for a cost per unit time.

FIG. 8 is a flowchart showing a method for providing an advertisement according to an exemplary embodiment of the present invention. The method for providing an advertisement according to the present embodiment may be performed by the system for providing an advertisement. In FIG. 8, the method for providing an advertisement will be described by describing a process in which each operation is performed by the system for providing an advertisement.

At operation S801, the system for providing an advertisement determines a bidding starting price for each keyword based on a minimum cost per click for a keyword and the number of expected clicks for the keyword. Here, the minimum cost per click and the number of expected clicks may be determined through various methods.

For example, the minimum cost per click may be determined based on a vacancy rate for each keyword. Here, the vacancy rate may include a rate of a non-sold area within an area in which an advertisement is exposed. That is, a cost preset according to the rate of the non-sold area within an area included in at least one of advertisement products exposing an advertisement for the keyword may be determined as the minimum cost per click. In addition, the minimum cost per click may also be determined based on at least one of the sale of an advertisement that is exposed through a pre-selected area, a number of clicks of the advertisement, a sale of the same business type advertisement that has been exposed through the area, and a number of clicks of the same business type advertisement. Here, various weights such as a weight for stabilizing a rate or a weight for using business type information may also be applied to the number of clicks, the sale, and the like, as needed.

The number of expected clicks may be determined based on an intermediate value for the exposure number of n advertisements measured on a predetermined date and an expected click rate or be determined based on the exposure number for which charging is valid and an expected click rate. For example, the number of expected clicks may be determined based on an intermediate value for the exposure number of five advertisements measured on September, 7 and the expected click rate or at least one of the exposure number for which charging is valid and the expected click rate. Here, the expected click rate may include a click rate of an advertisement exposed through a pre-selected area. For example, as the expected click rate, an expected click rate of a fifth exposed advertisement of advertisements exposed as a single advertisement product may be used.

When a variation in the bidding starting price for each keyword is a pre-selected magnitude or more, a changed value of the bidding starting price for each keyword may be used. For example, a pre-selected magnitude for updating is set to 10%, thereby making it possible to allow the changed value to be used only after the bidding starting price for each keyword is determined and a difference of 10% or more therein is then generated. In addition, the number of change is limited such as once a month, as needed, thereby making it possible to prevent an excessive fluctuation in the bidding starting price for each keyword and induce stability. Further, before updating of the bidding starting price for each keyword, a predetermined grace period may also be provided so that an advertiser may recognize the updating.

At operation S802, the system for providing an advertisement determines an area in which an advertisement of an advertiser is to be exposed based on a bidding price per unit time input from the advertiser. Here, the bidding price per unit time may include an expectation cost of the advertiser for providing the advertisement of the advertiser through the area for at least one unit time.

In the present description, ‘time’ indicates a period of time from any time. Any time for any keyword and an advertisement exposure area (or a filed on a web page) according to the keyword may be determined by the system for providing an advertisement, an operator of the system for providing an advertisement, or an advertiser, as needed. For example, the system for providing an advertisement may divide a day into the total of 144 unit times having intervals of ten minutes for the keyword and the advertisement exposure area. In this case, an advertisement cost is calculated for each unit time based on a bidding price per unit time according to the keyword and the advertisement exposure area, rather than being calculated according to the click for link to the advertisement document, thereby making it possible to basically solve a problem of malicious click by the same user/group.

Here, the bidding price per unit time has a value of the bidding starting price for each keyword or more. That is, the system for providing an advertisement receives the bidding price per unit time of the bidding starting price for each keyword or more from the advertiser through the bidding starting price for each keyword to determine an area in which the advertisement of the advertiser is to be exposed, thereby making it possible to form an appropriate successful bidding price even for a less competitive keyword. In addition, the system for providing an advertisement uses a maximum bidding price as well as the bidding starting price for each keyword to allow the bidding price per unit time to be input based on the bidding starting price and the maximum bidding price, thereby making it possible to limit a maximum bidding range. The maximum bidding price may be used in order to prevent excessive competition from being generated between advertisers.

At operation S803, the system for providing an advertisement provides the advertisement of the advertiser through the area. Here, the system for providing an advertisement sets link to an advertisement document of the advertiser in a page provided to the user for a corresponding unit time, thereby making it possible to provide the advertisement. That is, as described in an example of FIG. 7, the link to an advertisement document corresponding to the advertisement is set together with text information, image information, and the like, in a search result page to be exposed in a terminal of the user, thereby making it possible to provide the advertisement of the advertiser.

In addition, at least one of a weight preset for each day of the week and a weight preset for a specific day may be provided to the bidding starting price for each keyword used as the bidding starting price. Here, the specific day may include at least one day of a holiday period and a period preset before and after the holiday period.

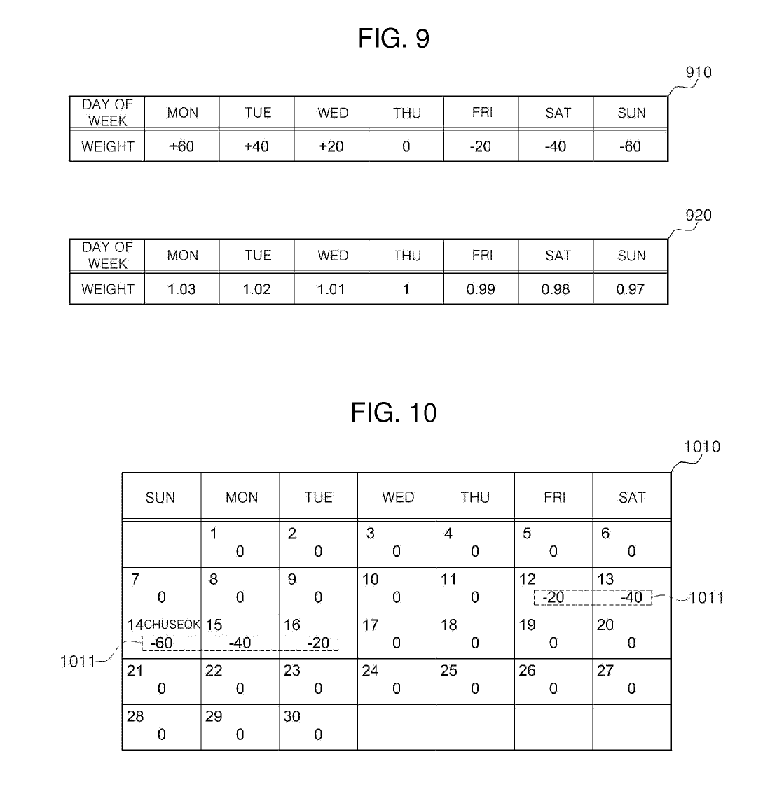

FIG. 9 is a view showing information on weights for each day of the week. First Table 910 represents an example in which direct amounts added to the bidding starting prices for each keyword are used as weights for each day of the week, and second Table 920 represents an example in which rates provided to the bidding starting prices for each keyword are used as weights for each day of the week. For example, when the bidding starting price for each keyword is ‘1,000’ won and a corresponding day of the week is ‘Monday’, the bidding starting price for each keyword may be finally determined to be ‘1,060 won’ (1,000 won+60 won). Here, ‘1,060 won’ may be provided to the advertisers, and a bidding price per unit time of ‘1,060 won’ or more may be input from the advertisers. A value of the weight according to the day of the week may be adjusted, as needed.

FIG. 10 is a view showing information on weights for a specific day. Table 1010 represents weights for a specific day of a month including a ‘Chuseok (Korean Thanksgiving Day)’ holiday period. That is, a dotted line box 1011 represents an example in which a ‘Chuseok’ holiday period and one days before and after the Chuseok' holiday period are included in the specific day. In FIG. 10, the weights for a specific day were determined so that as the date approaches ‘Chuseok’ for a specific day, the bidding starting price for each keyword becomes low. For example, when it is assumed that the bidding starting price for each keyword is ‘1,000 won’ throughout the ‘Chuseok’ holiday period, the bidding starting price for each keyword may be finally determined to be ‘980 won’ on September 12 and to be ‘940 won’ on September 14 to thereby be provided to the advertisers.

FIG. 11 is a table including information on weights for a day of the week and a specific day. Table 1110 represents 2-dimensional information including both of the weight preset for each day of the week and the weight for a specific day. For example, a weight ‘−100’ corresponding to ‘D-0’ and ‘Sunday’ means a weight in which the weight for a day of the week and the weight for a specific day are summed up. That is, the weight for a day of the week described in FIG. 9 and the weight for a specific day described in FIG. 10 may be separately used; however, they may be used together, as needed, as described in an example of FIG. 11.

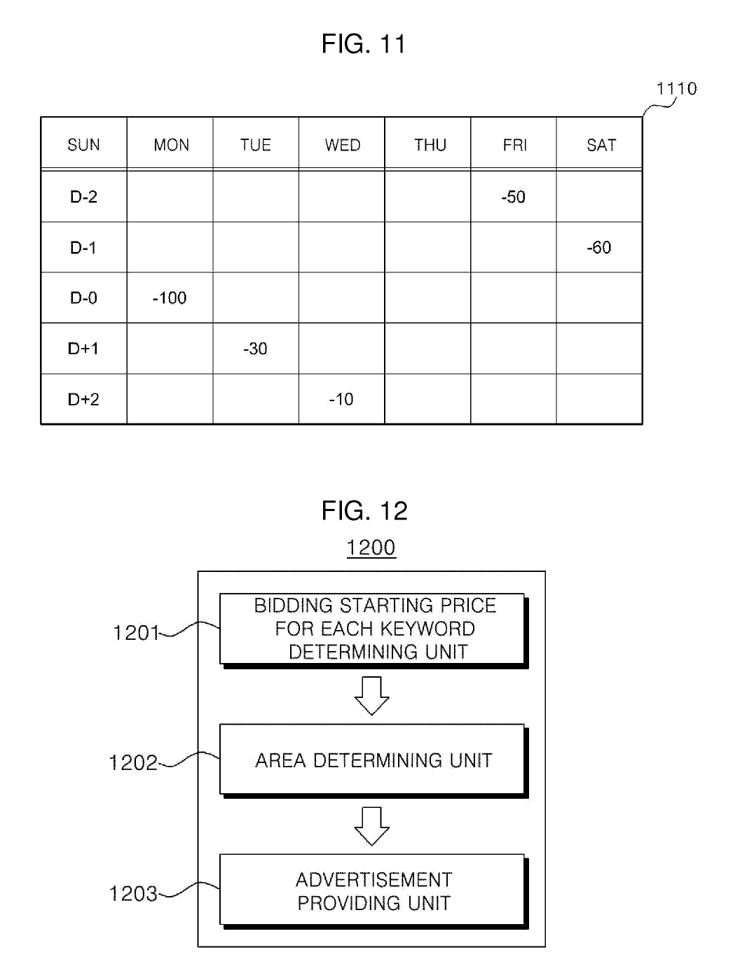

FIG. 12 is a block diagram describing an internal configuration of a system for providing an advertisement according to an exemplary embodiment of the present invention. A system 1200 for providing an advertisement according to the present embodiment includes a bidding starting price for each keyword determining unit 1201, an area determining unit 1202, and an advertisement providing unit 1203, as shown in FIG. 12.

The bidding starting price for each keyword determining unit 1201 determines a bidding starting price for each keyword based on a minimum cost per click for a keyword and the number of expected clicks for the keyword. Here, the minimum cost per click and the number of expected clicks may be determined through various methods.

For example, the minimum cost per click may be determined based on a vacancy rate for each keyword. Here, the vacancy rate may include a rate of a non-sold area within an area in which an advertisement is exposed. That is, a cost preset according to the rate of the non-sold area within an area included in at least one of advertisement products exposing an advertisement for the keyword may be determined as the minimum cost per click. In addition, a minimum cost per click may also be determined based on at least one of a sale of an advertisement that is exposed through a pre-selected area, a number of clicks of the advertisement, a sale of the same business type advertisement that has been exposed through the area, and a number of clicks of the same business type advertisement. Here, various weights such as a weight for stabilizing a rate or a weight for using business type information may also be applied to the number of clicks, the sale, and the like, as needed.

In addition, a number of expected clicks may be determined based on an intermediate value for the exposure number of n advertisements measured on a predetermined date and an expected click rate or be determined based on the exposure number for which charging is valid and an expected click rate. For example, a number of expected clicks may be determined based on an intermediate value for the exposure number of five advertisements measured on September, 7 and the expected click rate or at least one of the exposure number for which charging is valid and the expected click rate. Here, the expected click rate may include a click rate of an advertisement exposed through a pre-selected area. For example, as the expected click rate, an expected click rate of a fifth exposed advertisement of advertisements exposed as a single advertisement product may be used.

When a variation in the bidding starting price for each keyword is a pre-selected magnitude or more, a changed value of the bidding starting price for each keyword may be used. For example, a pre-selected magnitude for updating is set to 10%, thereby making it possible to allow the changed value to be used only after the bidding starting price for each keyword is determined and a difference of 10% or more therein is then generated. In addition, a number of changes are limited such as once a month, as needed, thereby making it possible to prevent an excessive fluctuation in the bidding starting price for each keyword and induce stability. Further, before updating of the bidding starting price for each keyword, a predetermined grace period may also be provided so that an advertiser may recognize the updating.

The area determining unit 1202 determines an area in which the advertisement of the advertiser is to be exposed based on a bidding price per unit time input from the advertiser. Here, the bidding price per unit time may include an expectation cost of the advertiser for providing the advertisement of the advertiser through the area for at least one unit time.

Here, the bidding price per unit time has a value of the bidding starting price for each keyword or more. That is, when the bidding price per unit time of the bidding starting price for each keyword or more is input from the advertiser through the bidding starting price for each keyword, the area determining unit 1202 determines an area in which the advertisement of the advertiser is to be exposed based on the bidding price per unit time, thereby making it possible to form an appropriate successful bidding price even for a less competitive keyword. In addition, the system 1200 for providing an advertisement uses a maximum bidding price as well as the bidding starting price for each keyword to allow the bidding price per unit time to be input based on the bidding starting price and the maximum bidding price, thereby making it possible to limit a maximum bidding range. The maximum bidding price may be used in order to prevent excessive competition from being generated between advertisers.

The advertisement providing unit 1203 provides the advertisement of the advertiser through the area. Here, the advertisement providing unit 1203 sets link to an advertisement document of the advertiser in a page provided to the user for a corresponding unit time, thereby making it possible to provide the advertisement. That is, as described in an example of FIG. 7, the link to an advertisement document corresponding to the advertisement is set together with text information, image information, and the like, in a search result page to be exposed in a terminal of the user, thereby making it possible to provide the advertisement of the advertiser.

As described above, with the method for providing an advertisement according to the exemplary embodiment of the present invention or the system for providing an advertisement according to the exemplary embodiment of the present invention, the bidding starting price for each keyword is determined for the advertisement product sold through bidding for unit time and the advertisement of the advertiser is provided through a determined area according to the input bidding price per unit time based on the bidding starting price for each keyword, thereby making it possible to prevent a successful bidding price from being formed at a significantly low cost for a less competitive keyword and determine a bidding starting price according to a day of the week or a holiday period through weights preset for each day of the week or a specific day. Furthermore, only when a variation in the bidding starting price is a pre-selected magnitude or more, a changed value thereof is used, thereby making it possible to prevent an excessive fluctuation in the bidding starting price and induce stability.

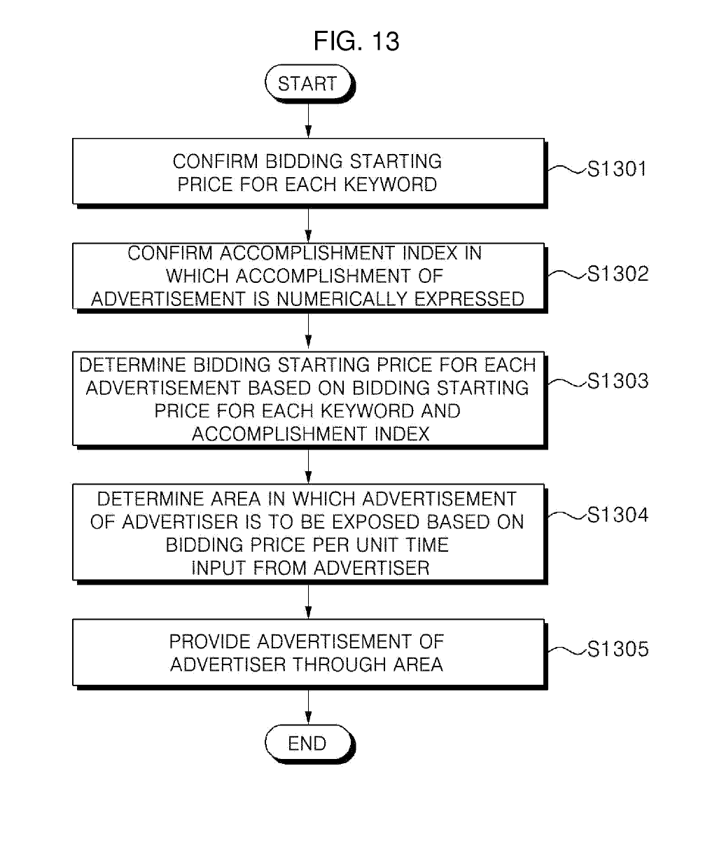

FIG. 13 is a flowchart showing a method for providing an advertisement according to another exemplary embodiment of the present invention. The method for providing an advertisement according to the present embodiment may be performed by the system for providing an advertisement according to another exemplary embodiment of the present invention. In FIG. 13, the method for providing an advertisement will be described by describing a process in which each operation is performed by the system for providing an advertisement.

At operation S1301, the system for providing an advertisement confirms a bidding starting price for each keyword. Here, the bidding starting price for each keyword may be determined based on a minimum cost per click for a keyword and the number of expected clicks for the keyword, and the system for providing an advertisement may confirm the determined bidding starting price for each keyword.

For example, the minimum cost per click may be determined based on a vacancy rate for each keyword. Here, the vacancy rate may include a rate of a non-sold area within an area in which an advertisement is exposed. That is, a cost preset according to the rate of the non-sold area within an area included in at least one of advertisement products exposing an advertisement for the keyword may be determined as the minimum cost per click. In addition, the minimum cost per click may also be determined based on at least one of the sale of an advertisement that is exposed through a pre-selected area, a number of clicks of the advertisement, a sale of the same business type advertisement that has been exposed through the area, and a number of clicks of the same business type advertisement. Here, various weights such as a weight for stabilizing a rate or a weight for using business type information may also be applied to the number of clicks, the sale, and the like, as needed. In addition, the number of expected clicks may be determined based on an intermediate value for the exposure number of n advertisements measured on a predetermined date and an expected click rate or be determined based on the exposure number for which charging is valid and an expected click rate. For example, the number of expected clicks may be determined based on an intermediate value for the exposure number of five advertisements measured on September, 7 and the expected click rate or at least one of the exposure number for which charging is valid and the expected click rate. Here, the expected click rate may include a click rate of an advertisement exposed through a pre-selected area. For example, as the expected click rate, an expected click rate of a fifth exposed advertisement of advertisements exposed as a single advertisement product may be used.

At operation S1302, the system for providing an advertisement confirms an accomplishment index in which the accomplishment of the advertisement is numerically expressed. Here, the accomplishment index may be used in order to set the bidding starting prices to be lower as the accomplishment of advertisements becomes lower, thereby inducing more advertisers to participate in auction and set the bidding starting prices to be higher as the accomplishment of the advertisements becomes higher, thereby maximizing an auction profit. The accomplishment index may be calculated based on, for example, a rate between the number of clicks expected that a corresponding advertisement obtains for a predetermined period and the number of clicks actually obtained for the period.

At operation S1303, the system for providing an advertisement determines a bidding starting price for each advertisement based on the bidding starting price for each keyword and the accomplishment index. For example, the system for providing an advertisement may determine the bidding starting price for each advertisement for a corresponding advertisement by applying a rate based on an accomplishment index of the corresponding advertisement to the bidding starting price for each keyword.

When a variation in the bidding starting price for each advertisement is a pre-selected magnitude or more, a changed value of the bidding starting price for each advertisement may be used. For example, a pre-selected magnitude for updating is set to 10%, thereby making it possible to allow the changed value to be used only after the bidding starting price for each advertisement is determined and a difference of 10% or more therein is then generated. In addition, a number of changes are limited such as once a month, as needed, thereby making it possible to prevent an excessive fluctuation in the bidding starting price for each advertisement and induce stability. Further, before updating of the bidding starting price for each advertisement, a predetermined grace period may also be provided so that an advertiser may recognize the updating.

At operation S1304, the system for providing an advertisement determines an area in which an advertisement of an advertiser is to be exposed based on a bidding price per unit time input from the advertiser. At this time, the bidding price per unit time is input based on the bidding starting price for each advertisement. For example, the bidding price per unit time may have a value of the bidding starting price for each advertisement or more. That is, when the bidding price per unit time of the bidding starting price for each advertisement or more is input from the advertiser through the bidding starting price for each advertisement, the system for providing an advertisement determines an area in which the advertisement of the advertiser is to be exposed based on the bidding price per unit time, thereby making it possible to form an appropriate successful bidding price even for a less competitive keyword. In addition, the system for providing an advertisement uses a maximum bidding price as well as the bidding starting price for each advertisement to allow the bidding price per unit time to be input based on the bidding starting price for each advertisement and the maximum bidding price, thereby making it possible to limit a maximum bidding range. The maximum bidding price may be used in order to prevent excessive competition from being generated between advertisers.

At operation S1305, the system for providing an advertisement provides the advertisement of the advertiser through the area. Here, the system for providing an advertisement sets link to an advertisement document of the advertiser in a page provided to the user for a corresponding unit time, thereby making it possible to provide the advertisement. That is, as described in an example of FIG. 7, the link to an advertisement document corresponding to the advertisement is set together with text information, image information, and the like, in a search result page to be exposed in a terminal of the user, thereby making it possible to provide the advertisement of the advertiser.

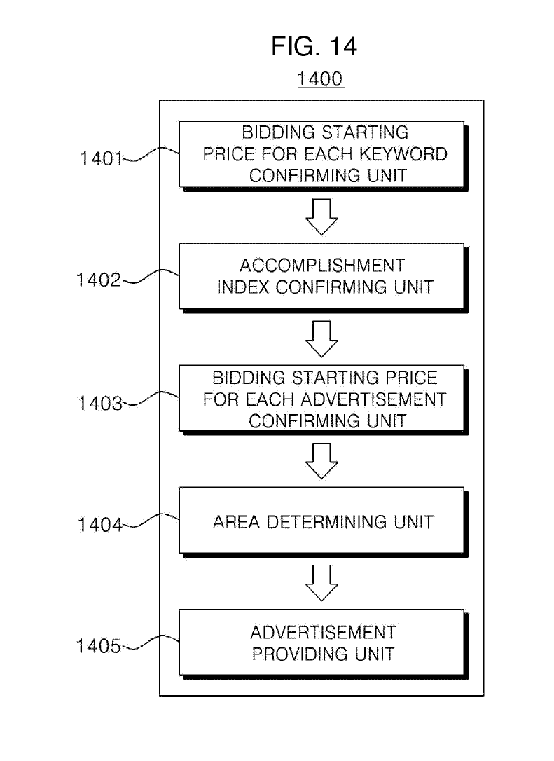

FIG. 14 is a block diagram describing an internal configuration of a system for providing an advertisement according to another exemplary embodiment of the present invention. A system 1400 for providing an advertisement according to the present embodiment includes a bidding starting price for each keyword confirming unit 1401, an accomplishment index confirming unit 1402, a bidding starting price for each advertisement confirming unit 1403, an area determining unit 1404, and an advertisement providing unit 1405, as shown in FIG. 14.

The bidding starting price for each keyword confirming unit 1401 confirms a bidding starting price for each keyword. Here, the bidding starting price for each keyword may be determined based on a minimum cost per click for a keyword and the number of expected clicks for the keyword, and the bidding starting price for each keyword confirming unit 1401 may confirm the determined bidding starting price for each keyword.

For example, the minimum cost per click may be determined based on a vacancy rate for each keyword. Here, the vacancy rate may include a rate of a non-sold area within an area in which an advertisement is exposed. That is, a cost preset according to the rate of the non-sold area within an area included in at least one of advertisement products exposing an advertisement for the keyword may be determined as the minimum cost per click. In addition, the minimum cost per click may also be determined based on at least one of the sale of an advertisement that is exposed through a pre-selected area, the number of clicks of the advertisement, the sale of the same business type advertisement that has been exposed through the area, and the number of clicks of the same business type advertisement. Here, various weights such as a weight for stabilizing a rate or a weight for using business type information may also be applied to a number of clicks, a sale, and the like, as needed. In addition, a number of expected clicks may be determined based on an intermediate value for the exposure number of n advertisements measured on a predetermined date and an expected click rate or be determined based on the exposure number for which charging is valid and an expected click rate. For example, the number of expected clicks may be determined based on an intermediate value for the exposure number of five advertisements measured on September, 7 and the expected click rate or at least one of the exposure number for which charging is valid and the expected click rate. Here, the expected click rate may include a click rate of an advertisement exposed through a pre-selected area. For example, as the expected click rate, an expected click rate of a fifth exposed advertisement of advertisements exposed as a single advertisement product may be used.

The accomplishment index confirming unit 1402 confirms an accomplishment index in which the accomplishment of the advertisement is numerically expressed. Here, the accomplishment index may be used in order to set the bidding starting prices to be lower as the accomplishment of advertisements becomes lower, thereby inducing more advertisers to participate in auction and set the bidding starting prices to be higher as the accomplishment of the advertisements becomes higher, thereby maximizing an auction profit. The accomplishment index may be calculated based on, for example, a rate between the number of clicks expected that a corresponding advertisement obtains for a predetermined period and the number of clicks actually obtained for the period.

The bidding starting price for each advertisement confirming unit 1403 determines a bidding starting price for each advertisement based on the bidding starting price for each keyword and the accomplishment index. For example, the bidding starting price for each advertisement confirming unit 1403 may determine the bidding starting price for each advertisement for a corresponding advertisement by applying a rate based on an accomplishment index of the corresponding advertisement to the bidding starting price for each keyword.

When a variation in the bidding starting price for each advertisement is a pre-selected magnitude or more, a changed value of the bidding starting price for each advertisement may be used. For example, a pre-selected magnitude for updating is set to 10%, thereby making it possible to allow the changed value to be used only after the bidding starting price for each advertisement is determined and a difference of 10% or more therein is then generated. In addition, a number of changes are limited such as once a month, as needed, thereby making it possible to prevent an excessive fluctuation in the bidding starting price for each advertisement and induce stability. Further, before updating of the bidding starting price for each advertisement, a predetermined grace period may also be provided so that an advertiser may recognize the updating.

The area determining unit 1404 determines an area in which the advertisement of the advertiser is to be exposed based on a bidding price per unit time input from the advertiser. At this time, the bidding price per unit time is input based on the bidding starting price for each advertisement. For example, the bidding price per unit time may have a value of the bidding starting price for each advertisement or more. That is, when the bidding price per unit time of the bidding starting price for each advertisement or more is input from the advertiser through the bidding starting price for each advertisement, the area determining unit 1404 determines an area in which the advertisement of the advertiser is to be exposed based on the bidding price per unit time, thereby making it possible to form an appropriate successful bidding price even for a less competitive keyword. In addition, the system 1400 for providing an advertisement uses a maximum bidding price as well as the bidding starting price for each keyword to allow the bidding price per unit time to be input based on the bidding starting price and the maximum bidding price, thereby making it possible to limit a maximum bidding range. The maximum bidding price may be used in order to prevent excessive competition from being generated between advertisers.

The advertisement providing unit 1405 provides the advertisement of the advertiser through the area. Here, the system for providing an advertisement sets link to an advertisement document of the advertiser in a page provided to the user for a corresponding unit time, thereby making it possible to provide the advertisement. That is, as described in an example of FIG. 7, the link to an advertisement document corresponding to the advertisement is set together with text information, image information, and the like, in a search result page to be exposed in a terminal of the user, thereby making it possible to provide the advertisement of the advertiser.

As described above, with the method for providing an advertisement according to the exemplary embodiment of the present invention or the system for providing an advertisement according to the exemplary embodiment of the present invention, the bidding starting price for each advertisement, which is a bidding starting price according to the advertisement, is determined based on the bidding starting price for each keyword and the accomplishment index in which the accomplishment of the advertisement is numerically expressed, thereby making it possible to induce an appropriate successful bidding price for each advertisement and determine a bidding starting price according to a day of the week or a holiday period through weights preset for each day of the week or a specific day. In addition, only when a variation in the bidding starting price is a pre-selected magnitude or more, a changed value thereof is used, thereby making it possible to prevent an excessive fluctuation in the bidding starting price and induce stability.

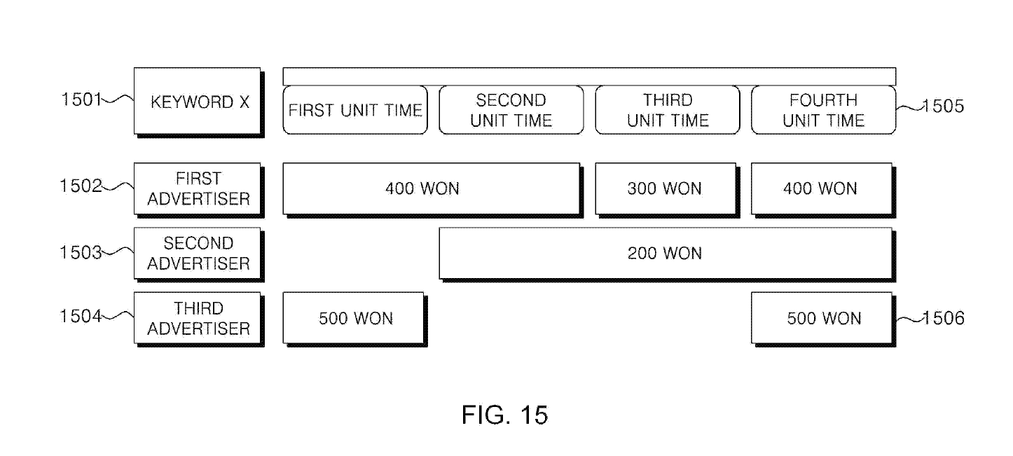

FIG. 15 is a view describing a bidding price per unit time. The bidding price per unit time means a bidding price for unit time rather than a bidding price for click. FIG. 15 shows an example of a bidding price per unit time which a first advertiser 1502, a second advertiser 1503, and a third advertiser 1504 input for unit time, with respect to a keyword X 1501. Here, it may be appreciated that the first advertiser 1502 suggests each of bidding prices per unit time of 400 won for first and second unit times, 300 won for a third unit time, and 400 won for a fourth unit time 1505. When it is assumed that sale is performed with respect to a corresponding unit time only at a bidding price per unit time, an advertisement of the third advertiser 1504 suggesting 500 won 1506, which is a highest bidding price per unit time with respect to the fourth unit time 1505 may be exposed for the fourth unit time 1505, with respect to the keyword X 1501. As described above, according to the exemplary embodiments of the present invention, the advertisement cost is calculated for each unit time based on the bidding price per unit time according to the keyword and the advertisement exposure area, rather than being calculated according to the click for link to the advertisement document, thereby making it possible to basically solve a problem of malicious click by the same user/group.

According to the present invention, a more accurately determined bidding starting prices is used, thereby making it possible to provide greater convenience to the advertiser at the time of bidding and determine the advertisement cost at a more reasonable level.

According to the present invention, trust relationship between the advertiser and the advertisement provider is enhanced, thereby making it possible to maintain and expand a search advertisement market and increase profit of the advertisement provider.

According to the present invention, the bidding starting price for each keyword is determined for the advertisement product sold through bidding for unit time and the advertisement of the advertiser is provided through a determined area according to the input bidding price per unit time based on the bidding starting price for each keyword, thereby making it possible to prevent a successful bidding price from being formed at a significantly low cost for a less competitive keyword.

According to the present invention, the bidding starting prices for each advertisement, which is a bidding starting price according to the advertisement, are determined based on the bidding starting price for each keyword and the accomplishment index in which the accomplishment of the advertisement is numerically expressed, thereby making it possible to induct an appropriate successful bidding price for each advertisement.

According to the present invention, it is possible to determine a bidding starting price according to a day of the week or a holiday period through weights preset for each day of the week or a specific day.

According to the present invention, only when a variation in the bidding starting price is a pre-selected magnitude or more, a changed value thereof is used, thereby making it possible to prevent an excessive fluctuation in the bidding starting price and induce stability.

According to the present invention, the advertisement cost is calculated for each unit time based on the bidding price per unit time according to the keyword and the advertisement exposure area, rather than being calculated according to the click for link to the advertisement document, thereby making it possible to basically solve a problem of malicious click by the same user/group.

The exemplary embodiments according to the present invention are implemented in a form of program commands capable of being performed through various computer components to thereby be recordable in a computer-readable recording medium. The computer-readable recording medium may include program commands, data files, data structures, or the like, alone or in combination. The program command recorded in the computer-readable recording medium may be designed and constituted especially for the present invention, or may be known to those skilled in a field of computer software. Examples of the computer-readable recording medium may include a magnetic medium such as a hard disk, a floppy disk, and a magnetic tape; an optical recording medium such as a CD-ROM, a DVD; a magneto-optical medium such as a floptical disk; and a hardware device specially constituted to store and perform program commands such as a ROM, a RAM, a flash memory, or the like. Examples of the program commands may include machine language codes such as being made by compilers as well as high-level language codes capable of being executed by computers using interpreters, or the like. The hardware device may be constituted to be operated as one more software modules in order to perform the action according to the present invention, and vise versa.

Hereinabove, although the present invention is described by specific matters such as concrete components, and the like, exemplary embodiments, and drawings, they are provided only for assisting in the entire understanding of the present invention. Therefore, the present invention is not limited to the exemplary embodiments. Various modifications and changes may be made by those skilled in the art to which the present invention pertains from this description.

Therefore, the sprit of the present invention should not be limited to the above-described exemplary embodiments, and the following claims as well as all modified equally or equivalently to the claims are intended to fall within the scopes and spirits of the invention.

1. A method for providing an advertisement, the method comprising:
calculating a bidding starting price based on past data with respect to a search keyword for a search advertisement;
transmitting the bidding starting price to an advertiser arithmetic unit;
receiving bidding information on the search advertisement from the advertiser arithmetic unit, the bidding information including information on a time during which the search advertisement is to be published and a bidding price for the search advertisement;
determining a publication position and/or a publication order of the search advertisement based on an amount of the bidding price corresponding to a predetermined time period within the time during which the search advertisement is to be published in the predetermine time period; and
publishing the search advertisement according to the determined publication position and/or publication order for the predetermined time period,
wherein the bidding starting price is considered based on a certain range.

2. The method of claim 1, wherein the past data comprises at least one of a publication number of the search advertisement for a past predetermined time, a click number of advertisement information on the search advertisement, a bidding price for the search advertisement, or a charging amount for the search advertisement.

3-5. (canceled)

6. A method for providing an advertisement, the method comprising:
calculating a bidding starting price based on past data with respect to a search keyword for a search advertisement;
transmitting the bidding starting price to an advertiser arithmetic unit;
receiving bidding information on the search advertisement from the advertiser arithmetic unit, the bidding information comprising information of time during which the search advertisement is to be published and a bidding price for the search advertisement;
determining a publication position and/or a publication order of the search advertisement based on an amount of the bidding price corresponding to a predetermined time period within the time during which the search advertisement is to be published for the predetermine time period; and
publishing the search advertisement according to the determined publication position and/or publication order for the predetermined time period,
wherein the bidding starting price is discounted based on a depth for the search keyword.

7. The method of claim 6, wherein the past data comprises at least one of a publication number of the search advertisement for a past predetermined time, a click number of advertisement information on the search advertisement, a bidding price for the search advertisement, or a charging amount for the search advertisement.

8. The method of claim 6, wherein the discount is applied if the depth is less than the number of publishable search advertisements.

9. The method of claim 8, wherein a discount rate of the discount is in proportion to a difference value between the number of publishable search advertisements and the depth.

10. A system for providing an advertisement, the system comprising:
an auction managing unit configured to calculate a bidding starting price based on past data with respect to a search keyword for a search advertisement, to transmit the bidding starting price to an advertiser arithmetic unit, and to receive bidding information on the search advertisement from the advertiser arithmetic unit, the bidding information comprising information based on time during which the search advertisement is to be published and a bidding price for the search advertisement; and
an advertisement executing unit configured to determine a publication position and/or a publication order of the search advertisement based on an amount of the bidding price corresponding to a predetermined time period within the time during which the search advertisement is to be published in the predetermine time period and to publish the search advertisement according to the determined publication position and/or publication order for the predetermined time period,
wherein the bidding starting price is calculated based on a number of search bid advertisements with respect to the search keyword which becomes at least a number of publishable search advertisements.

11. The system of claim 10, wherein the past data comprises at least one of a publication number of the search advertisement for a past predetermined time, a click number of advertisement information on the search advertisement, a bidding price for the search advertisement, or a charging amount for the search advertisement.

12. The system of claim 10, wherein the bidding starting price is determined if the number of search bid advertisements with respect to the search keyword occur at least the number of publishable search advertisements.

13. The system of claim 10, wherein the bidding starting price is determined if the number of search bid advertisements with respect to the search keyword occur at least the number of publishable search advertisements for a recent predetermined time.

14. The system of claim 10, wherein the bidding starting price is determined if the number of search bid advertisements with respect to the search keyword occur at least the number of publishable search advertisements for a recent predetermined time.

15. A system for providing an advertisement, the system comprising:
an auction managing unit configured to calculate a bidding starting price based on past data with respect to a search keyword for a search advertisement, to transmit the bidding starting price to an advertiser arithmetic unit, and to receive bidding information on the search advertisement from the advertiser arithmetic unit, the bidding information comprising information of time during which the search advertisement is to be published and a bidding price for the search advertisement; and
an advertisement executing unit to determine a publication position and/or a publication order of the search advertisement based on an amount of the bidding price corresponding to a predetermined time period within the time during which the search advertisement is to be published in the predetermine time period and to publish the search advertisement according to the determined publication position and/or publication order for the predetermined time period,
wherein the bidding starting price is discounted based on a depth for the search keyword.

16. The system of claim 15, wherein the past data comprises at least one of a publication number of the search advertisement for a past predetermined time, a click number of advertisement information on the search advertisement, a bidding price for the search advertisement, or a charging amount for the search advertisement.

17. The system of claim 15, wherein the discount is applied when the depth is less than the number of publishable search advertisements.

18. The system of claim 17, wherein a discount rate of the discount is determined in proportion to a difference value between the number of publishable search advertisements and the depth.

19-44. (canceled)

45. The method of claim 1, wherein the certain range is a range where a number of search bid advertisements with respect to the search keyword is at least the number of publishable search advertisements.

46. The method of claim 45, wherein the bidding starting price is determined to be in a range comprising the number of search bid advertisements with respect to the search keyword that has occurred, the number of search bid advertisements with respect to the search keyword being at least the number of publishable search advertisements.

47. The method of claim 45, wherein the bidding starting price is determined to be in a range comprising the number of search bid advertisements with respect to the search keyword that occurred at least once for a recent time period, the number of search bid advertisements with respect to the search keyword being at least the number of publishable search advertisements.

48. The method of claim 45, wherein the bidding starting price is determined to be in a range comprising the number of search bid advertisements with respect to the search keyword that occurred at least certain times for a recent time period, the number of search bid advertisements with respect to the search keyword being at least the number of publishable search advertisements.
